(19) United States
(12) Patent Application Publication
(10) Pub. No.: US 2012/0064386 A1
(43) Pub. Date: Mar. 15, 2012

(54) BATTERY MODULE

(75) Inventors: Kosuke OGURI, Wako (JP); Masahiko NATSUUME, Wako (JP); Masao KAWATA, Wako (JP)

(73) Assignee: HONDA MOTOR CO., LTD., Tokyo (JP)

(21) Appl. No.: 13/232,068

(22) Filed: Sep. 14, 2011

(30) Foreign Application Priority Data
Sep. 14, 2010 (JP) 2010-205927

(51) Int. Cl. H01M 2/10

(52) U.S. Cl. 429/156

(57) ABSTRACT

A battery module includes a plurality of rectangular cells, holders, first and second end plates and joining members. The joining members join the first and second end plates to fasten the plurality of rectangular cells and the holders to be a single unit. Ends of the joining members are fastened to first securing parts and second securing parts on the first and second end plates. The first securing parts and the second securing parts are disposed at both ends of a center line that penetrates through centers of the plurality of rectangular cells, the holders, and the first and second end plates. A distance between the center line and each of the first and second securing parts is smaller than a distance between each of the first and second securing parts and each of outermost surfaces of the first and second end plates.

### CROSS-REFERENCE TO RELATED APPLICATIONS

The present application claims priority under 35 U.S.C. §119 to Japanese Patent Application No. 2010-205927, filed Sep. 14, 2010, entitled “Battery Module”. The contents of this application are incorporated herein by reference in their entirety.

### BACKGROUND OF THE INVENTION

1. Field of the Invention

The present invention relates to a battery module.

2. Discussion of the Background

There is a known battery assembly (battery module) including rectangular unit batteries (cell) aligned in parallel, a partition maintaining constant intervals of the unit batteries, an end plate closely contacting the outer side of the outermost unit battery, and a joining rod connecting the unit batteries, the partition, and the end plate (see Japanese Unexamined Patent Application Publication No. 2006-310309).

### SUMMARY OF THE INVENTION

According to one aspect of the present invention, a battery module includes a plurality of rectangular cells, holders, first and second end plates and joining members. The plurality of rectangular cells are aligned in parallel at predetermined intervals. The holders are interposed between adjacent cells among the plurality of rectangular cells. The first and second end plates are disposed at outer sides in an alignment direction of the plurality of rectangular cells and the holders to fasten the plurality of rectangular cells and the holders to be a single unit. The joining members join the first and second end plates to fasten the plurality of rectangular cells and the holders to be a single unit. The joining members extend in the alignment direction. Ends of the joining members are fastened to first securing parts and second securing parts on the first and second end plates. The first securing parts and the second securing parts are disposed at both ends of a center line that penetrates through centers of the plurality of rectangular cells, the holders, and the first and second end plates and that extends in the alignment direction. A distance between the center line and each of the first and second securing parts is smaller than a distance between each of the first and second securing parts and each of outermost surfaces of the first and second end plates.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is an exploded perspective view illustrating, in outline, a battery module according to an embodiment of the present invention.

FIG. 2 is a side view of the battery module from the direction of arrow II in FIG. 1.

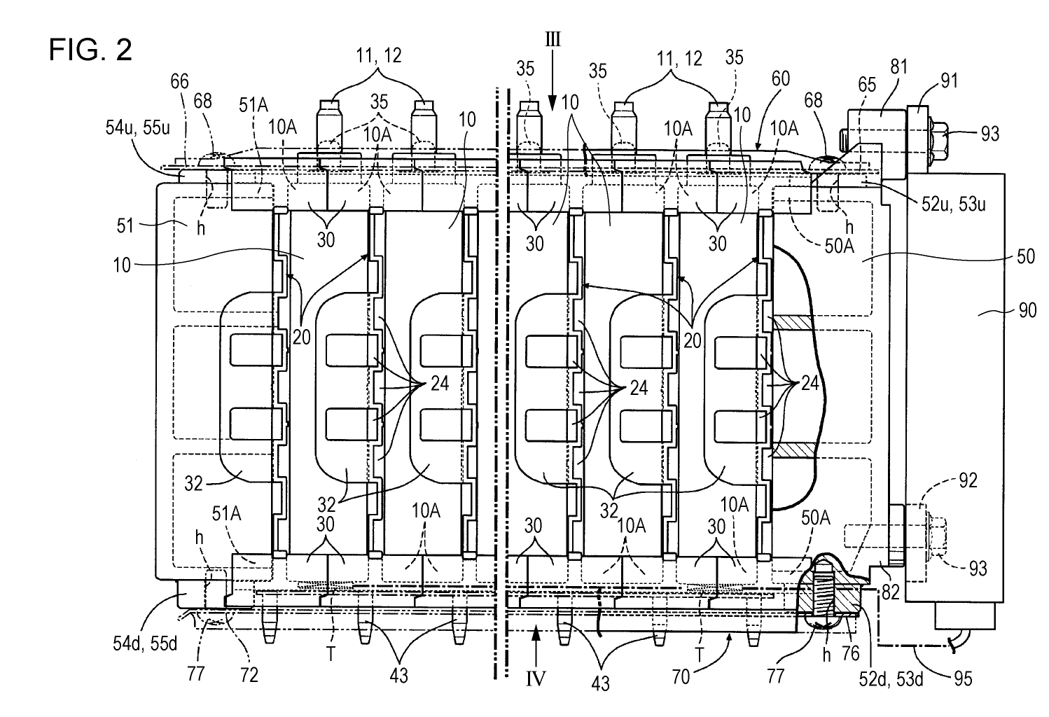

FIG. 3 is a plan view of the battery module from the direction of arrow III in FIG. 2.

FIG. 4 is a bottom view of the battery module from the direction of arrow IV in FIG. 2.

FIG. 5 is an enlarged view of the area represented by reference numeral V, which is surrounded by the chain-dashed line, in FIG. 1.

FIG. 6 is a perspective view of a holder from the direction indicated by arrow VI in FIG. 5.

FIG. 7 is an enlarged sectional view taken along line VII-VII in FIG. 3.

FIG. 8 is an enlarged sectional view taken along line VIII-VIII in FIG. 7.

FIG. 9 is an enlarged perspective view from the direction indicated by arrow IX in FIG. 1.

FIG. 10 is an enlarged sectional view taken along line X-X in FIG. 9.

### DESCRIPTION OF THE EMBODIMENTS

The embodiments will now be described with reference to the accompanying drawings, wherein like reference numerals designate corresponding or identical elements throughout the various drawings.

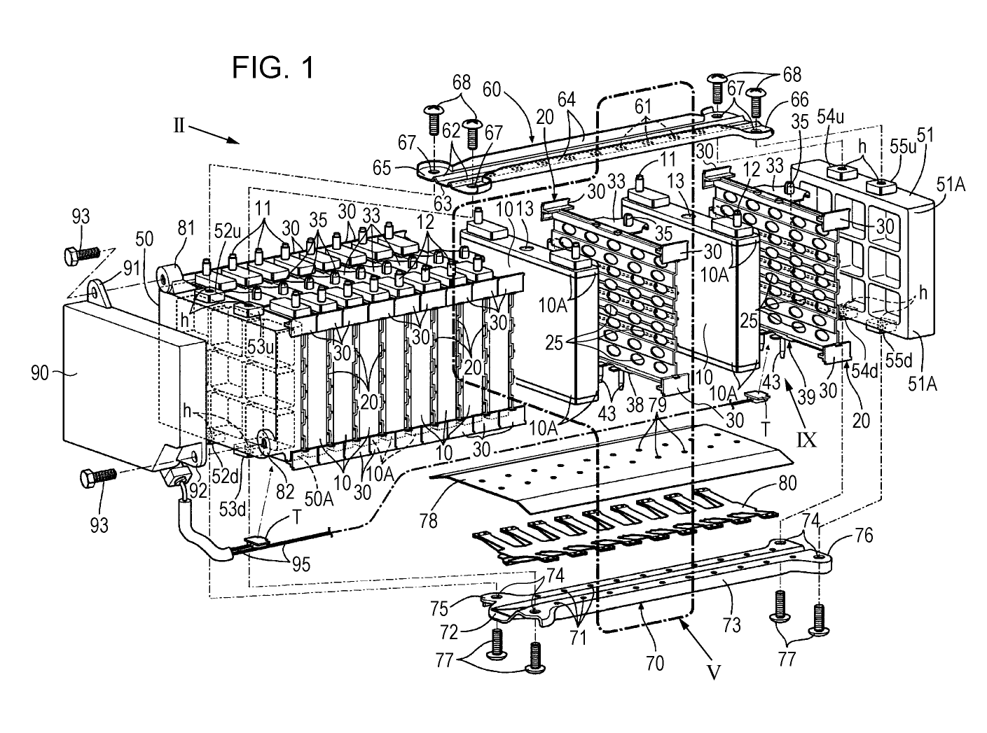

As illustrated in FIG. 1, a battery module according to the embodiment of the present invention includes a plurality of rectangular cells 10 aligned in parallel at predetermined intervals, a plurality of holders 20 interposed between adjacent cells and on the outer sides of the outermost cells 10, a rectangular end plate 50 disposed on the outer side of one of the outermost holders 20, and another rectangular end plate (base end plate) 51 disposed on the outer side of the other outermost holder 20. The cells 10 and the holders 20, which are closely in contact with each other, are fastened by the paired end plates 50 and 51. The end plates 50 and 51 are joined into a single unit with an upper joining frame 60 and a lower joining frame 70, which are joining members. A voltage sensor assembly (voltage sensor) 90 is attached to the outer side of the end plate 50.

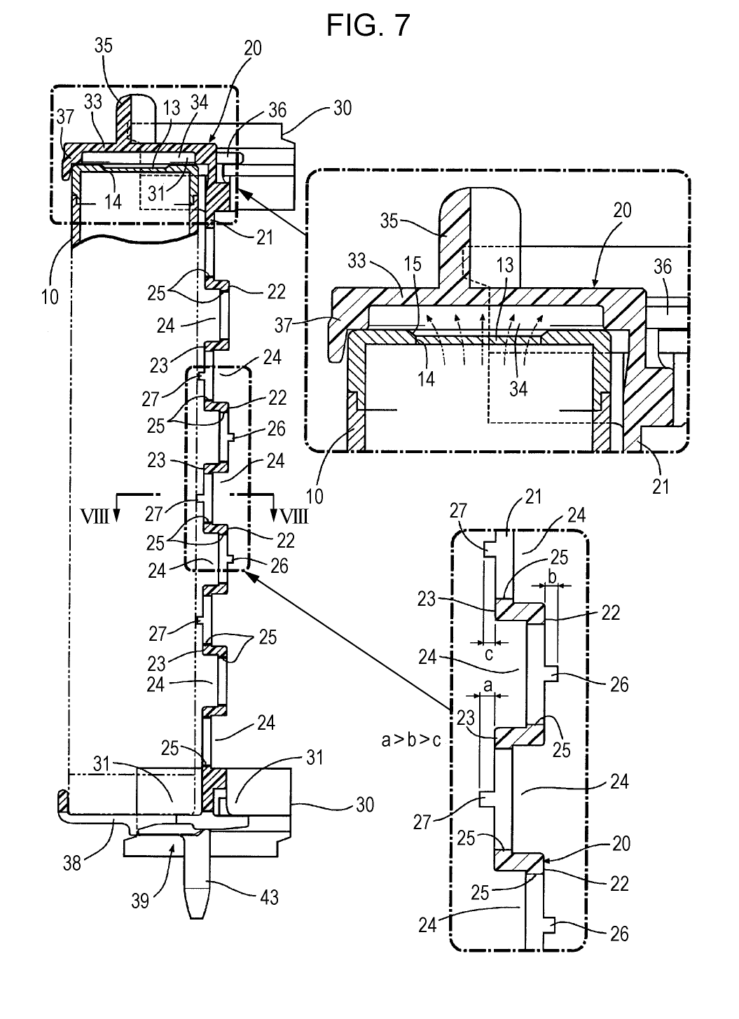

The rectangular cells 10 have a known structure in which positive and negative electrodes 11 and 12 protrude from the left and right ends of the upper surface of a flat cuboid and a valve port 14 (FIG. 7) closed by an explosion-proof valve 13 is disposed at the center of the upper surface.

Each of the holders 20 is interposed between adjacent cells 10 in parallel and holds the cells 10 at predetermined intervals to provide heat insulating spaces between the cells 10. The structure of the holders 20 will be described below mainly with reference to FIGS. 1, 5, 6, and 7.

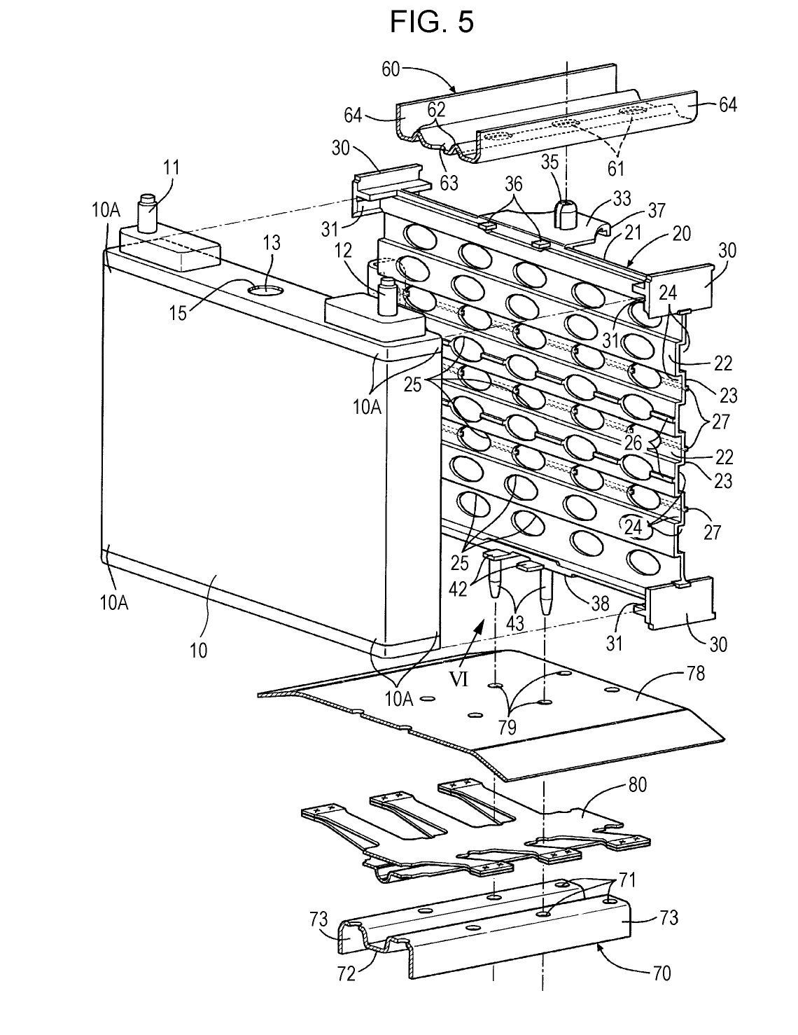

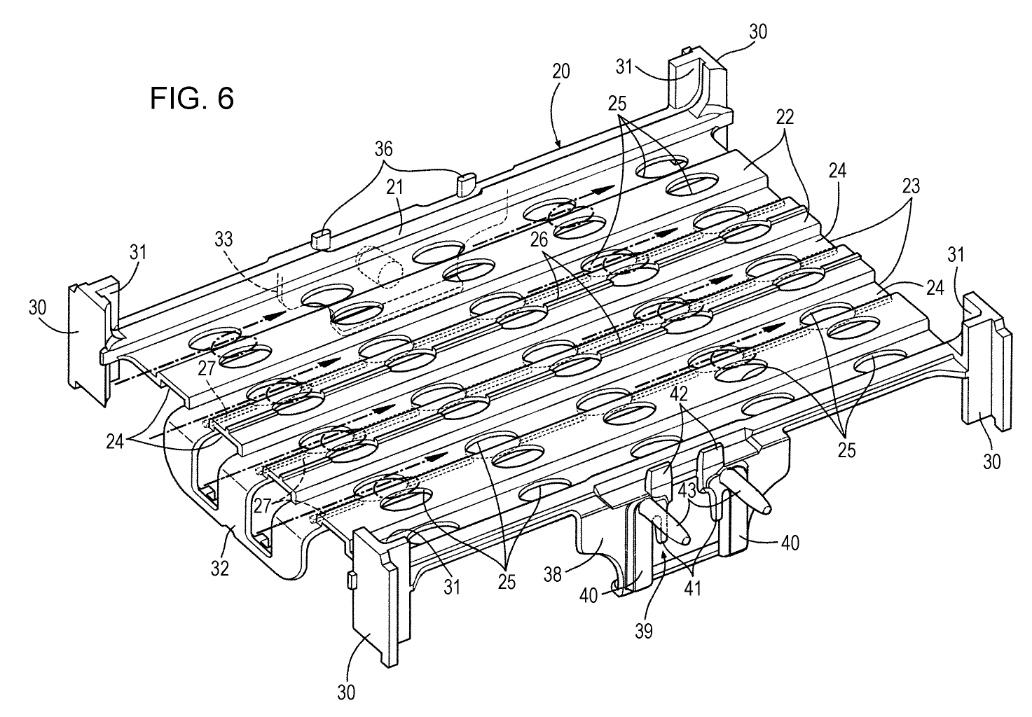

The main component 21 of each of the holders 20 is a rectangular plate made of synthetic resin and is substantially the same size as the cells 10. The main component 21 of the holder 20 has first protruding parts 22 and second protruding parts 23, which extend in transverse directions parallel to each other and have a squared U-shape cross-section. The first protruding parts 22 and the second protruding parts 23 are formed by alternately bending the main component 21 in the vertical direction in a corrugated manner. The inner sections of the first protruding parts 22 and the second protruding parts 23 form transverse cooling paths 24, which are open at the left and right ends and have a depressed cross-section. The entire surface of the main component 21 has circular vents 25, which allow coolants, such as cool air, to evenly circulate. Specifically, as illustrated in FIGS. 5 and 6, the vents 25 are formed in the upper and lower sections and the first and second protruding parts 22 and 23 of the main component 21. The vents 25 disturb the coolant flow along the front and back surfaces of the holder 20 to increase the cooling efficiency of the holder 20.

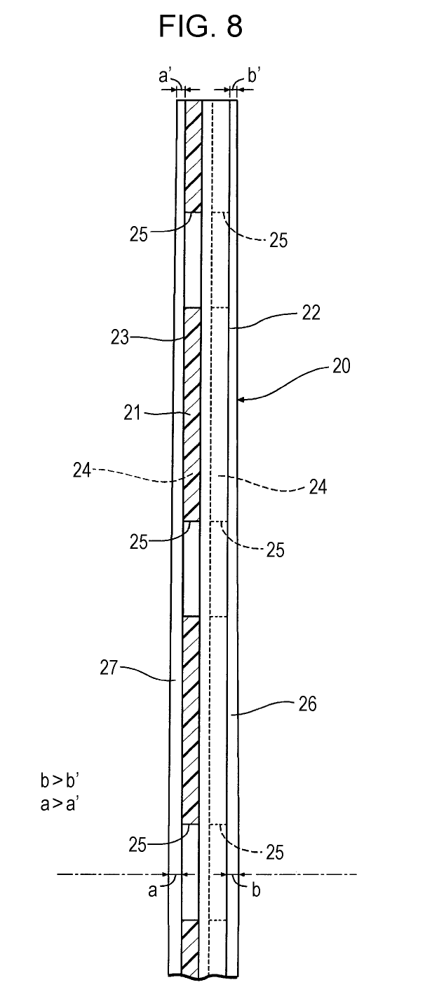

As illustrated in FIGS. 5 and 6, ribs 26 and 27, which extend in the longitudinal direction of the first protruding parts 22 and the second protruding parts 23, are integrated with and protrude from the vertically-middle sections of the outer surfaces of the first protruding parts 22 and the second protruding parts 23, which are disposed in the middle section of the main component 21 of the holder 20. The ribs 26 and 27 reinforce the holder 20 and maintain the distance between adjacent cells 10, which sandwich the holder 20, during assembly of the battery module. As illustrated in FIGS. 7 and 8, the height of the ribs 26 and 27 is set such that the height a of the rib 27 corresponding to the center area of the main component 21 is the greatest, and the height b of the ribs 26 and the height c of the ribs 27 become smaller in the outward direction (a>b>c). The heights b and c of the ribs 26 and 27 along the longitudinal direction of the ribs 26 and 27 is greatest at the center area and become gradually smaller toward the tips, i.e., the ends of the main component 21, such that the heights a′ and b′ of the tips are the smallest. By setting the heights of the ribs 26 and 27 in this way, bulging of the center area of the cells 10 can be prevented by the holders 20 during assembly of the battery module.

As illustrated in FIGS. 5 and 6, holding members 30 are fixed at the four corners of the main component 21 of each holder 20. Each holding member 30 is made of an angle bar and protrudes outward from the front or back surface of the main component 21 of the holder 20. During assembly of the battery module, the angle depressions 31 of each holding member 30 engage with the four holding parts 10A, 50A, or 51A, which are provided on the cells 10, the end plate 50, or the end plate 51. In this way, the cells 10 and the end plates 50 and 51 can be aligned at the regular assembly position, without being displaced with respect to each other. A pressing piece 32 is formed by bending the middle section on one side of the main component 21 of each holder 20. The pressing piece 32 holds a side of the corresponding cell 10.

As illustrated in FIGS. 5 and 7, a holder piece 33 is integrated with the middle section, in the width direction, of the upper surface of each holder 20. The holder piece 33 is bent at a substantially perpendicular angle to the front or back surface of the holder 20, i.e., is substantially horizontal, has a vertical wall 37 extending in the direction of the cells 10, has a gate-shape cross section, and is cantilevered toward the front or back of the holder 20. When assembling the battery module, the holder piece 33 covers the upper surface of the explosion-proof valve 13, which covers the valve port 14, at the center area of the upper surface of the adjacent cell 10 such that a gap 34 is formed between the holder piece 33 and the explosion-proof valve 13. A funnel-shape inclined surface 15, having a slope rising toward the upper surface of the cell 10, is formed on the circumference of the valve port 14. An ejected substance, such as electrolyte gas, that is discharged when the valve port 14 is opened is once received and liquefied by the holder piece 33. Then, the liquefied ejected substance flows along the inclined surface 15 on the circumference of the valve port 14 and returns to the cell 10. Subsequently, the ejected substance is retained in the gap 34 to prevent the ejected substance from being dispersed outside (see FIG. 7).

A positioning projection 35 is integrated with and protrudes from the upper surface of the holder piece 33 and is fit into a positioning hole 61 in the upper joining frame 60, which is a joining member described below. Engagement pieces 36, which are engaged with the upper surfaces of adjacent cells 10 are integrated with the base of the holder piece 33.

As illustrated in FIG. 6, an attachment frame 38 of a thermistor T, which is described below, is integrated with the center area, in the width direction, of the lower surface of the holder 20. The attachment frame 38 is bent at a substantially perpendicular angle in the same direction as the holder piece 33, i.e., is substantially horizontal, and is cantilevered toward the front or back of the holder 20.

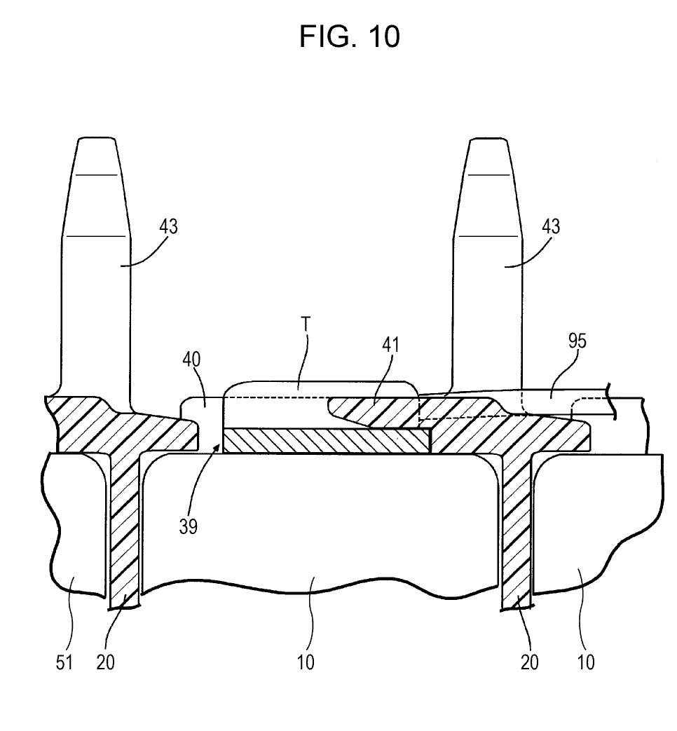

The structure of the attachment frame 38 will be described below mainly with reference to FIGS. 6, 9, and 10. A thermistor attachment part 39 for selectively and detachably attaching the thermistor T, which measures the cell temperature, is disposed on the attachment frame 38. Paired guides 40, which guide the thermistor T, are integrated with the outer surface of the attachment frame 38 and are disposed parallel to each other. Adjacent to the guides 40, paired pressing pieces 41 for holding the thermistor T are disposed. Paired engagement pieces 42, which engage with the lower surface of the cells 10 adjoining the holder 20 and preventing loosening of the thermistor T, extend from the base of the attachment frame 38 in a direction opposite to the extending direction of the pressing pieces 41. Paired positioning protrusions 43, which fit into positioning holes 71 in the lower joining frame 70, which is a joining member, are integrated with the guides 40.

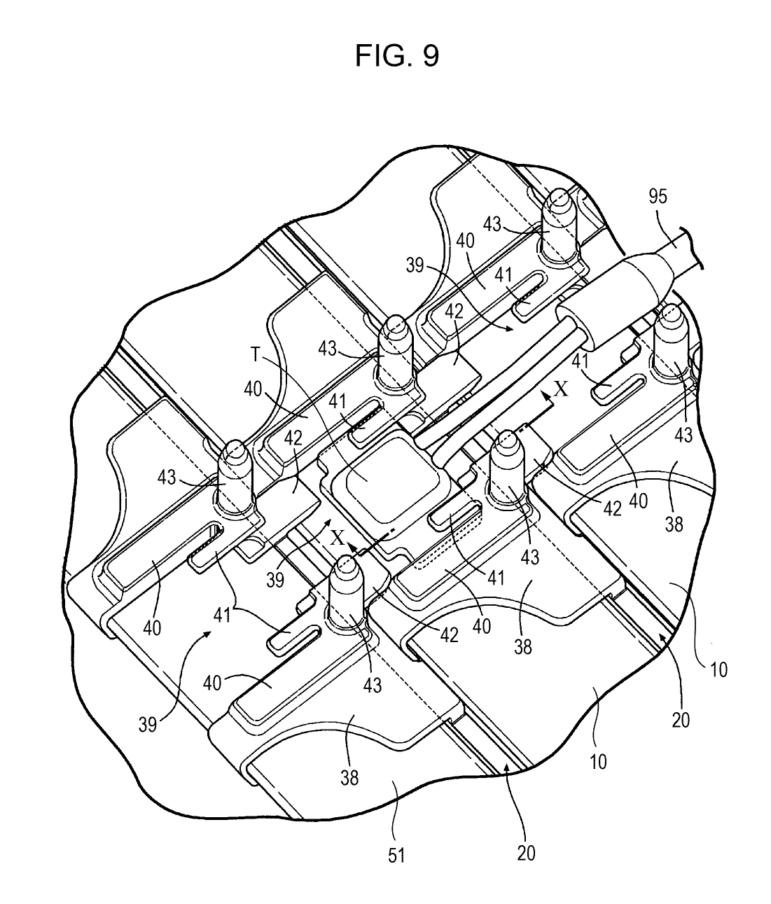

As illustrated in FIG. 9, the thermistor T is interposed between the paired guides 40 and is held in a predetermined position by the paired pressing pieces 41. The temperature sensor of the thermistor T contacts the lower surface of the cell 10 to measure the temperature of the cell 10. The position of the thermistor T can be easily confirmed visually from outside. Leads 95, which are connected to the thermistor T, are connected a voltage sensor assembly 90, which is described below.

As illustrated in FIG. 1, the paired end plates 50 and 51, which fasten, from the outside, the cells 10 and the holders 20 aligned in parallel, are flat cuboids, which are substantially the same shape as the cells 10 and the holders 20. The paired end plates 50 and 51 are aligned with the outermost cells 10 with the holders 20 interposed therebetween.

The paired end plates 50 and 51 are made of metal (for example, magnesium alloy). The inner surfaces of the paired end plates 50 and 51, i.e., the surfaces opposing the holders 20, form a grid, which has a small heat transmission area and excellent radiation performance. The holders 20, which function as heat insulation, are interposed between the end plates 50 and 51 and the cells 10 to prevent excessive cooling of the cells 10.

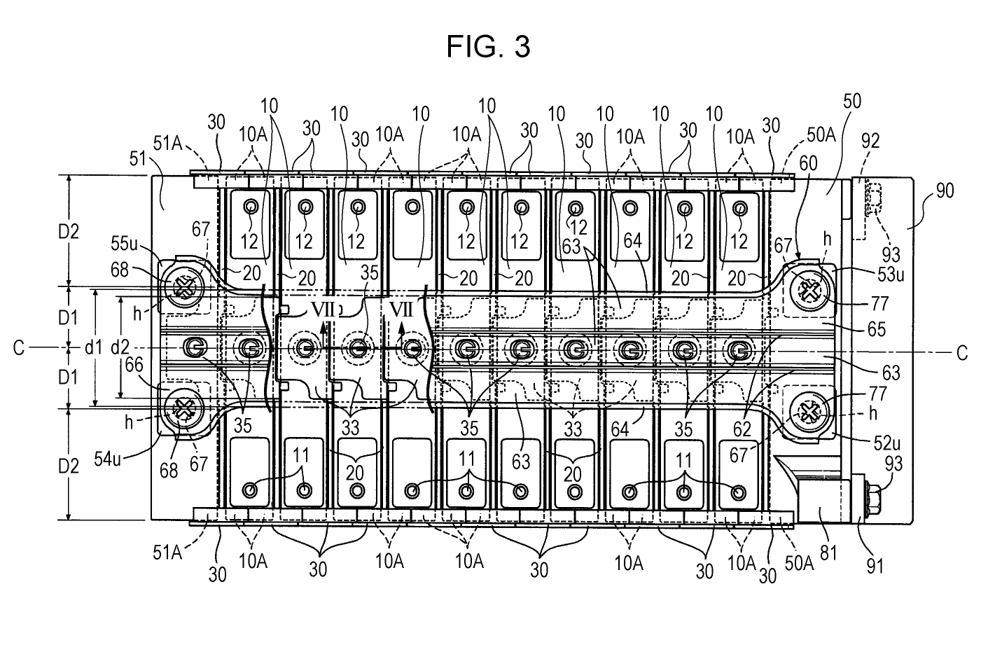

The end plates 50 and 51 are joined together into a single unit by the upper joining frame 60 and the lower joining frame 70, which are joining members, as described below. As illustrated in FIGS. 1, 3, and 4, first and second securing parts 52u and 53u and first and second securing parts 54u and 55u, which join the upper joining frame 60, are integrated with the upper surfaces of the paired end plates 50 and 51; first and second securing parts 52d and 53d and first and second securing parts 54d and 55d, which join the lower joining frame 70, are integrated with the lower surfaces of the paired end plates 50 and 51. The first securing parts 52u and 54u (52d and 54d) and second securing parts 53u and 55u (53d and 55d) are rectangular blocks disposed at a predetermined distance from each other on the center areas in the width direction of the end plates 50 and 51. Joining holes h are formed at the centers of the securing parts. The joining holes are substantially orthogonal to a center line C-C, penetrating through the centers of the cells 10, the holders 20, and the paired end plates 50 and 51 and extending along the alignment direction of these components (FIG. 3), and extend inward in the vertical direction of the end plates 50 and 51. As illustrated in FIG. 3, the distance D1 from each of the centers the first securing parts 52u and 54u (52d and 54d) and the second securing parts 53u and 55u (53d and 55d) to the center line C-C is smaller than the distance D2 from each of the centers of the securing parts to each of the outermost surfaces of the end plates 50 and 51 (D1<D2).

As illustrated in FIGS. 1 and 3, the upper joining frame 60 is made of a long and thin metal plate and includes a flat part 63, which has positioning holes 61 and protruding ribs 62 aligned and extending in the longitudinal direction, and flange pieces 64 integrated with and erected from both sides of the upper joining frame 60. The flat part 63 and the flange pieces 64 form a U-shaped cross-section that provides excellent rigidity. Paired joining pieces 65 and 66, protruding in the transverse direction from both ends of the upper joining frame 60, are integrated with the upper joining frame 60 and have bolt holes 67.

As illustrated in FIG. 3, the upper joining frame 60 is disposed along the center line C-C, which penetrates through the centers of the cells 10 and the holders 20 and extends along the direction these the cells 10 and the holders 20 are aligned. The positioning holes 61 in the upper joining frame 60 are fit with the positioning projections 35 on the upper surfaces of the holders 20 to position the upper joining frame 60 with respect to the cells 10 and the holders 20. The joining pieces 65 and 66 at both ends of the upper joining frame 60 are positioned on the first securing parts 52u and 54u and the second securing parts 53u and 55u on the upper surface of the paired end plates 50 and 51. Then, the joining bolts 68 are screwed into the joining holes h in the first securing parts 52u and 54u and the second securing parts 53u and 55u through the bolt holes 67 in the joining pieces 65 and 66. In this way, the upper joining frame 60 fastens the paired end plates 50 and 51 into a single unit.

As illustrated in FIG. 3, the width d₁ of the flat part 63 of the upper joining frame 60 is wider than the width d₂ of the holder piece 33, and the flat part 63 covers the entire upper surface of the holder piece 33. In this way, dispersion of an ejected substance, such as electrolyte gas, discharged when the explosion-proof valve 13 is opened is primarily prevented, as described above, and is secondarily prevented by the upper joining frame 60.

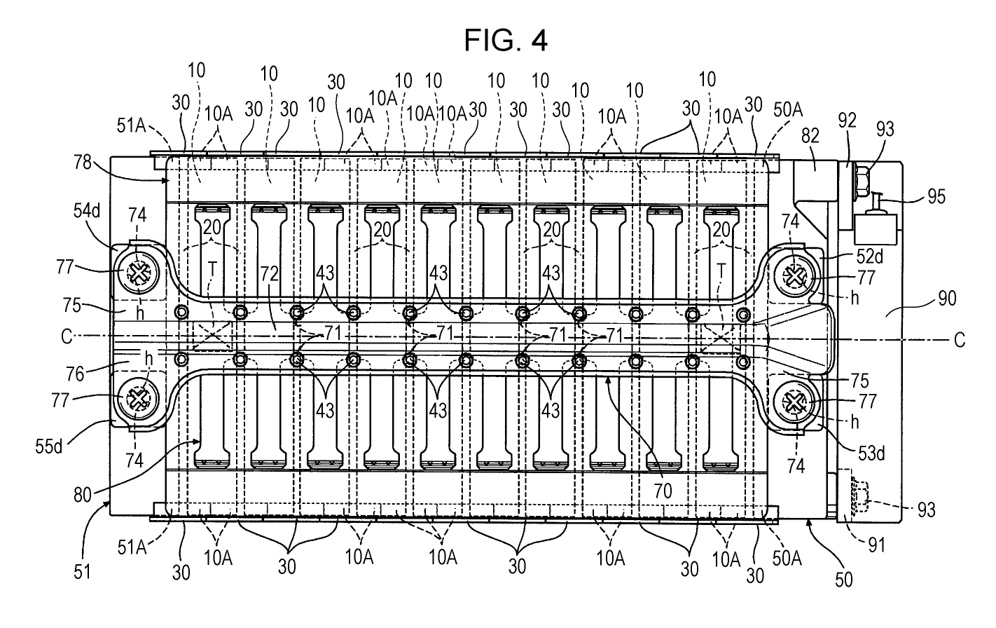

As illustrated in FIGS. 1 and 4, the lower joining frame 70 is substantially the same shape as the upper joining frame 60 and includes a flat part 72, which has positioning holes 71 aligned in two rows, and flange pieces 73 integrated with and erected from both sides of the lower joining frame 70. The flat part 72 and the flange pieces 73 form a U-shaped cross-section that provides excellent rigidity. Paired joining pieces 75 and 76, protruding in the transverse direction from both ends of the lower joining frame 70, are integrated with the lower joining frame 70 and have bolt holes 74.

As illustrated in FIGS. 1 and 4, a cover plate 78 covers the lower surfaces of the cells 10 and the holders 20. A rib-shaped flat spring 80 is disposed on the lower surface of the cover plate 78. The lower joining frame 70 is disposed on the lower surface of the cells 10 and the holders 20 with the cover plate 78 and the flat spring 80 interposed therebetween. The lower joining frame 70 joins the lower surface of the end plates 50 and 51 into a single unit. As illustrated in FIG. 4, the lower joining frame 70 is disposed on the lower surfaces of the cells 10 and the holders 20 with the cover plate 78 and the flat spring 80 interposed therebetween and is disposed along the center line C-C, which penetrates through the centers of the cells 10 and the holders 20 and extends along the alignment direction of the cells 10 and the holders 20. The positioning protrusions 43 on the attachment frame 38 are passed through the through-holes 79 in the cover plate 78 and the flat spring 80 (see FIG. 5) and fit into the positioning holes 71. In this way, the cells 10, the holders 20, and the lower joining frame 70 are positioned. The joining pieces 75 and 76 at both ends of the lower joining frame 70 are positioned on the first securing parts 52d and 54d and the second securing parts 53d and 55d on the lower surface of the paired end plates 50 and 51. Then, the joining bolts 77 are screwed into the joining holes h in the first securing parts 52d and 54d and the second securing parts 53d and 55d through the bolt holes 74 in the joining pieces 75 and 76. In this way, the lower joining frame 70 fastens the paired end plates 50 and 51 into a single unit.

Accordingly, the paired end plates 50 and 51 clamping the cells 10 and the holders 20 aligned in parallel are fastened into a single unit by the upper joining frame 60 and the lower joining frame 70, which are joining members. In this state, as illustrated in FIG. 3, since the distance D1 from each of the centers the first securing parts 52u and 54u (52d and 54d) and the second securing parts 53u and 55u (53d and 55d) to the center line C-C of the cells 10 and the holders 20 is smaller than the distance D2 from each of the centers of the securing parts to each outermost surface of the end plates 50 and 51 (D1<D2), the upper joining frame 60 and the lower joining frame 70 efficiently prevent bulging (which is greatest at the center areas) of the cells 10 due to degradation, and thus degradation of the battery module can be prevented.

Since the joining holes h for joining the joining members are orthogonal with the alignment direction of the first securing parts 52u and 54u (52d and 54d) and the second securing parts 53u and 55u (53d and 55d) of the paired end plates 50 and 51 and extend inward in the end plates 50 and 51, the joining parts of the upper joining frame 60 and the lower joining frame 70, which are joining members, do not protrude further outward than the outer surfaces of the end plates 50 and 51, and thus the size of the battery module can be reduced. Since the joining holes h extend inward in the end plates 50 and 51, even if fastening units, such as bolts, fastening the end plates 50 and 51 and the joining members 60 and 70, loosen due to vibration, the fastened state of the cells 10 and the holders 20 can be maintained.

Moreover, the bulging at the center areas of the cells 10 can be reliably prevented by the ribs 26 and 27 of the holders 20.

As illustrated in FIG. 1, the voltage sensor assembly 90 is secured to the outer surface of the end plate 50. The voltage sensor assembly 90 is a flat cuboid that is slightly smaller than the end plate 50. The heat conductivity and volume of the voltage sensor assembly 90 is smaller than the end plate 50. Attachment pieces 91 and 92 protrude from diagonal positions of the voltage sensor assembly 90. Attachment bosses 81 and 82, which correspond to the attachment pieces 91 and 92, respectively, protrude from diagonal positions on the end plate 50. The attachment pieces 91 and 92 and the attachment bosses 81 and 82 are joined by joining bolts 93 to secure the voltage sensor assembly 90 on the outer surface of the end plate 50 with a gap formed therebetween.

The end plate 50 doubles as a rigid member of the casing of the voltage sensor assembly 90 and contributes to improving the rigidity of the voltage sensor assembly 90. The voltage sensor assembly 90 generates heat during discharge and charge. This heat is transmitted to the end plate 50, enhancing head radiation of the voltage sensor assembly 90, which is sensitive to heat.

As illustrated in FIG. 1, the thermistors T are selectively attached to the holders 20. In this embodiment, the thermistors T are attached to the outermost holders 20, i.e., the holder 20 interposed between the cell 10 and the end plate 50 and between the cell 10 and the end plate 51. The leads 95 connected to the thermistors T are connected to the voltage sensor assembly 90 to measure the temperature of the battery module.

A battery module according to the embodiment of the present invention includes a plurality rectangular cells aligned in parallel at predetermined intervals; holders interposed between adjacent cells; paired end plates disposed at outer sides in the alignment direction of the cells and the holders and fastening the cells and the holders into a single unit; and joining members joining the end plates and fastening the cells and the holders into a single unit, wherein the joining members extend in the alignment direction of the cells and the holders, the ends of the joining members are fastened to first securing parts and second securing parts on the end plates, the first securing parts and the second securing parts are disposed at both ends of a center line penetrating through the centers of the cells, the holders, and the end plates and in the alignment direction of the cells, the holders, and the paired end plates, and the distance between each of the securing parts and the center line is smaller than the distance between each of the securing parts and each of the outermost surfaces of the end plates.

In addition to the battery module according to the embodiment, joining holes joining the joining members may be provided in the first securing parts and the second securing parts, the joining holes extending in a direction substantially orthogonal to the alignment direction of the cell and the holders and inward of the end plates.

According to the embodiment of the present invention, the joining parts of the joining member do not protrude further outward than the outer surface of the end plates 50 and 51, and thus the size of the battery module can be reduced. Since the joining holes extend inward in the end plates, even if the fastening units, such as bolts, fastening the end plates and the joining members, loosen due to vibration, the fastened state of the cells and the holders can be maintained.

In addition to the battery module according to the embodiments, ribs may be disposed in parallel in a direction intersecting with the alignment direction of the cells and the holders, on at least surfaces of the holders opposing the cells, and the height of parts of the ribs corresponding to center areas of the cells may be larger than the height of other parts of the ribs.

According to the embodiment, the bulging at the center areas of the cells can be reliably prevented by the ribs of the holders.

In addition to the battery module according to the embodiment, the height of the ribs may be gradually reduced outward from the center areas of the holder.

According to the embodiment, the bulging at the center areas of the cells can be reliably prevented by the ribs of the holders.

The above-described embodiments of the present invention, degradation of the battery module can be prevented by preventing bulging of cells or, in particular, bulging of the center areas, which bulge the most, due to the process of overcharge, electrolyte resolution, vaporization, and battery inner pressure increase.

Obviously, numerous modifications and variations of the present invention are possible in light of the above teachings. It is therefore to be understood that within the scope of the appended claims, the invention may be practiced otherwise than as specifically described herein.

What is claimed is:

1. A battery module comprising:
a plurality of rectangular cells aligned in parallel at predetermined intervals;
holders interposed between adjacent cells among the plurality of rectangular cells;
first and second end plates disposed at outer sides in an alignment direction of the plurality of rectangular cells and the holders to fasten the plurality of rectangular cells and the holders to be a single unit; and
joining members joining the first and second end plates to fasten the plurality of rectangular cells and the holders to be a single unit, the joining members extending in the alignment direction, ends of the joining members being fastened to first securing parts and second securing parts on the first and second end plates, the first securing parts and the second securing parts being disposed at both ends of a center line that penetrates through centers of the plurality of rectangular cells, the holders, and the first and second end plates and that extends in the alignment direction, a distance between the center line and each of the first and second securing parts being smaller than a distance between each of the first and second securing parts and each of outermost surfaces of the first and second end plates.

2. The battery module according to claim 1, wherein joining holes joining the joining members are provided in the first securing parts and the second securing parts, the joining holes extending in a direction substantially orthogonal to the alignment direction of the cell and the holders and inward of the end plates.

3. The battery module according to claim 1, wherein
ribs are disposed in parallel to each other in a direction intersecting with the alignment direction of the cells and the holders, on at least surfaces of the holders opposing the cells, and
a height of parts of the ribs corresponding to center areas of the cells is larger than a height of other parts of the ribs.

4. The battery module according to claim 3, wherein a height of the ribs is gradually reduced outward from center areas of the holder.

5. The battery module according to claim 1, wherein the joining members include ribs extending in a longitudinal direction of the joining members, and flanges extending in the longitudinal direction and erected from both sides of the joining members.
